(19) United States
(12) Patent Application Publication
(10) Pub. No.: US 2006/0267373 A1
(43) Pub. Date: Nov. 30, 2006

(54) Motor vehicle door hinge for pivotal fitting of a vehicle door to a vehicle body

(76) Inventors: Lutz Maiwald, Bergneustadt (DE); Gunter Adam, Zschaitz-Ottewig (DE); Hans-Gerd Menne, Bergneustadt (DE); Christian Mobius, Frankenberg (DE)

Correspondence Address: BACHMAN & LAPOINTE, P.C., 900 CHAPEL STREET, SUITE 1201, NEW HAVEN, CT, 06510, US

(21) Appl. No.: 11/433,091

(22) Filed: May 12, 2006

(30) Foreign Application Priority Data
May 12, 2005 (DE) 10 2005 022 813.5

(51) Int. Cl. B60J 5/00

(52) U.S. Cl. 296/146.1

(57) ABSTRACT

The invention relates to a motor vehicle door hinge for the pivotal fitting of a vehicle door to a vehicle body, including a door member adapted to be fitted to the vehicle door and a pillar member adapted to be fitted to the vehicle body, these being pivotally interconnected. The invention further relates to a set of components for motor vehicle door hinges including a door member and a pillar member for the pivotal fitting of a vehicle door to a vehicle body. In order to provide a motor vehicle door hinge which can be manufactured particularly cost-effectively and furthermore to provide a set of components for the manufacture of a motor vehicle door hinge, the components of which permit the manufacture of at least two hinges which can be employed on a vehicle, provision is made in the case of the motor vehicle door hinge, that the pillar member and/or the door member are formed from at least two components, i.e. a base plate fittable on the vehicle side and a support arm fittable to the base plate. Regarding the set of components the arrangement provides that the set includes a base plate, fittable to the vehicle door and/or the vehicle body, and a support arm fittable to the base plate, the base plate and the support arm being adapted for the production of a door member and/or pillar member employable in at least two positions of a vehicle and the base plate and the support arm being pre-manufactured.

### BACKGROUND OF THE INVENTION

The invention relates to a motor vehicle door hinge for the pivotal fitting of a vehicle door to a vehicle body, including a door member adapted to be fitted to the vehicle door and a pillar member adapted to be fitted to the vehicle body, these being pivotally interconnected, the pillar member and/or the door member being composed of at least two components. The invention further relates to a set of components for motor vehicle door hinges comprising a door member and a pillar member for the pivotal fitting of a vehicle door to a vehicle body.

Known motor vehicle door hinges of the aforesaid type are manufactured from door and pillar members each in one piece which are pivotally interconnected e.g. by way of a hinge pin. The door and pillar members used for the manufacture of the motor vehicle door hinges are in this context in part manufactured with the involvement of considerable metal removing processing from cast, forged or extrusion profiled unmachined parts.

Apart from the resultant considerable expenditure in material and time, the in any event necessary toolings or moulds contribute to the high production costs of the hinge components, a considerable part of the costs resulting from the large quantities of materials to be scrapped.

Regarding the costs of manufacture of the motor vehicle door hinges, it is furthermore important that the hinges employed on a vehicle differ greatly from one another, depending on whether the hinge is to be employed for a front or back door, on the left side or right side, at the top or the bottom of the respective door. If there are no correspondencies a vehicle having four vehicle doors will in the extreme case require eight different door hinges. An additional cost-increasing factor in this context is moreover that frequently for the different hinges different blanks need to be employed.

A door hinge according to the generic clause composed of two components is also known from DE 41 03 199 A1. In the case of the door hinge there disclosed the rabbet region is, however, not solely formed by a single component but by both components. This precludes the universal usability of the door hinge.

### SUMMARY OF THE INVENTION

It is an object of the invention to provide a motor vehicle door hinge which can be manufactured particularly cost-effectively. The invention has as a further object the provision of a set of components for the manufacture of a motor vehicle door hinge, the components of which permit the manufacture of at least two hinges which can be employed on a vehicle.

The invention attains the objects by virtue of a motor vehicle door hinge, comprising the features of claim 1 and a set of components having the features of claim 12. Advantageous further embodiments of the invention are apparent from the dependent claims.

It is feature of the door hinge according to the invention that a base plate adapted to be provided on the vehicle side and a support arm adapted to be fitted to the base plate each form one of the two components.

In principle, it is already a considerable improvement as against the state of the art if either the door member or the pillar member is formed from at least two components. An appreciable cost reduction is attained, however, in particular if both the door member as well as the pillar member are each formed from two components, i.e. the base plate and the support arm.

The base plate of the pillar or door member in this context is always that component which is fitted to the vehicle, i.e. to a vehicle component, that is to say to the vehicle body or the vehicle door. The support arm, in turn, is fitted to the base plate and serves for accommodating coupling elements, for example a hinge pin, by means of which the interassociated pillar and door members can be interconnected in pivotal inter-relationship and thereby form the motor vehicle door hinge according to the invention.

The motor vehicle door hinge according to the invention is furthermore characterised in that one or both components of the motor vehicle door hinge, that is to say the door and/or the pillar member can be manufactured in a particularly cost-effective manner according to an advantageous further embodiment of the invention from base plates and support arms, produced in a sheet metal blanking procedure. For the formation of the door and/or pillar member it is merely necessary to interconnect the base plates and carrier arms which are as a rule of simple design.

Complicated shaping procedures, such as bending or machining, as are necessary with the door and pillar members known according to the state of the art, can, accordingly, be dispensed with. It is important in this context that the pillar and door members which are of complex design, are formed from base plates and support arms of simple design which can, accordingly, also be manufactured easily.

Moreover, the design according to the invention of the motor vehicle door hinge according to an advantageous further embodiment, providing for a standardised connection of the base plate to the support arm, permits the combination of a variety of support arms with a variety of base plates.

Apart from the manufacture of the support arm and the base plate from a sheet metal blank according to one alternative modification, a different modification of the invention provides that the base plate and/or the carrier arm is formed of a cast, forged or extruded component. This results in technical advantages as regards the pivot length for the pivoting axis of the motor vehicle door hinge. Moreover, the support of the support arm in relation to the base plate is improved and the possibility of integration of further functions is facilitated. In this context, in order to preserve the advantages of the motor vehicle door hinge according to the invention, it is advisable to limit the employment of cast, forged or extruded components to carrier arms and base plates of simple design.

In principle, the connection between the support arm and the base plate can be of optional design. However, in accordance with an advantageous embodiment of the invention, the base plate comprises an aperture for accommodating the support arm. This embodiment permits to interconnect the pillar and/or door members by a simple plugging together of the support arm and the base plate. This plug-in connection may be standardised in a particularly simple manner and thereby permits a particularly simple combination of a variety of support arms with a variety of base plates, provided these are designed in accordance with such standardisation.

As explained further above, the connection between the support arm and the base plate can be of any suitable design. Likewise, the design of the plug-in connection is, as a rule, not subject to any restraints. According to an advantageous further development, the connection between the support arm and the base plate is brought about, however, by press-fitting. This is characterised in particular in that in a simple manner a strong connection is brought about between the support arm and the base plate. Additional fastening procedures can, accordingly, be dispensed with.

According to a further embodiment of the invention, the base plate is connected by a bonding procedure, in particular by welding to the support arm. The welding connection as well is characterised by a particularly high reliability of the connection between the support arm and the base plate. By selecting modern welding procedures, such as, for example, laser welding or projection welding, the heat impact onto the components can be kept particularly low, so that distortion is effectively avoided. Moreover, the components can be connected particularly cheaply by welding and in contrast to press-fitting, the tolerance requirements are reduced.

According to a particularly advantageous embodiment of the invention, the support arm is fitted in an aperture of the base plate by way of a connecting region and is connected to the rear of the base plate in tight-fitting relationship by wedging up or riveting of the connecting region. In a particularly advantageous embodiment of this modification, the connecting region of the support arm is formed by a peg, which in the assembled state projects through the base plate and is connected at its free end to the base plate by riveting or wedging up.

In the case of such riveting, the peg is ideally longer than the thickness of the base plate and the base plate has a recess suitable for accommodating the riveting head. This connection is characterised by a particularly brief processing time and high reliability and low costs.

It is pointed out that besides the aforesaid interconnections based solely on deformative, bonding or frictional connection, also a combination of such modes of connection can be performed. Thus, according to a particular modification of the invention, provision is made for the support arm to be connected to the base plate both by riveting as well as by projection welding. In this manner, a connection is attained which has a particularly high strength so that it is also thereby possible to provide a motor vehicle hinge for special sets of requirements.

The projection welding which in combination with a form-fitting connection or alone may be used for producing the connection between the support arm and the base plate, is so performed according to an advantageous embodiment of the invention that the base plate or the support arm in its contact region comprises a welding seam. Such a design of the support arm or the base plate permits a particularly rapid manufacture of the door or pillar members.

According to a further advantageous embodiment of the invention, the base plate comprises a ledge produced advantageously by stamping, such that the base plate in the region of its rear side opposite the ledge is provided with a recess. This embodiment of the invention ensures to a particular degree that a support arm extending through the base plate which is connected to the base plate by welding and/or riveting and/or wedging up, forms no projection on the rear of the base plate.

The set of components according to the invention for a vehicle door hinge, comprising a door member and a pillar member for the pivotal fitting of a vehicle door to a vehicle body comprises at least one base plate adapted to be fitted to the vehicle door and/or the vehicle body and a support arm which is connectable to the base plate, the base plate and the support arm being adapted for the manufacture of a door member and/or pillar member which can be employed in at least two positions of a vehicle and wherein the base plate and the support arm are pre-manufactured.

The set of components according to the invention permits the particularly cost-effective manufacture of a door and/or pillar member which can be employed in at least two positions, i.e., for example, on two vehicle doors or at the top as well as the bottom of the same vehicle door. In this context, the usability in at least two positions can result for a variety of reasons. On the one hand, the use of an identical component on more than one vehicle door may be provided for even by the design thereof. As an alternative, it is possible, however, to produce the support arm and/or the base plate in such a manner that merely by different mutual orientation to one another they can be employed in more than one position.

Ideally, it may be possible to use two components for the production of all door and pillar members to be employed on a vehicle. In the event that further base plates and/or support arms are required, the set of components according to the invention may be supplemented by the required components so that all motor vehicle door hinges of a vehicle may be manufactured using the set of components.

Advantageously, a standardised connection position is provided, which permits optional combinations of all support arms and base plates contained in a set of components. As an alternative, it is, however, also possible to provide for two or more standardised connection systems in the set of components. This may apply particularly to the case, where certain combinations between support arms and base plates are to be excluded.

As has already been explained further above, the multiple usability of the at least one support arm and the at least one base plate contained in the set of components may result from various factors. However, according to an advantageous modification of the invention, the support arm is so designed that by reversal thereof it can be used for the manufacture of a door and/or pillar member employable in at least two positions of a vehicle. By reversibility within the scope of the present application, the meaning is intended that the support arm can be connected to the base plate in at least two positions, preferably turned around by 180°. This design of the invention permits a particularly cost-effective and simple manufacture of the door and/or pillar members and thereby reduces the costs of the motor vehicle door hinges which can be manufactured using the set of components.

Moreover, the components of the set may, in principle, be manufactured from optional materials. According to an advantageous embodiment of the invention, the base plate and the support arm are formed, however, from sheet metal blanks. These may be manufactured in a particularly cost-effective manner. In automated blanking processes it is, for example, possible to manufacture a multiplicity of identical or different support arms and base plates with only minor loss of material.

Alternatively, according to an advantageous further embodiment of the invention, provision is made for the base plate and/or the support arm to be formed from solid casting, forging or extrusion components. Technical advantages regarding load-bearing ability of the base plate and the support arm result from the use of such components. However, for cost reasons, the manufacture of the base plate and the support arm from a cast, forged or extruded profile component should be limited to components of simple design.

In principle, the connection, in particular an advantageously provided standardised connection between the base plate and the support arm, can be brought about in any suitable manner. According to a particularly advantageous embodiment of the invention the base plate, however, comprises an aperture for accommodating the support arm. A thereby resulting possibility of a plug-in connection represents a particularly simple manner of assembling the support arm and the base plate. The performance of the plug-in connection may in this context be performed in optional manner and be combined with other ways of connecting.

### BRIEF DESCRIPTION OF THE DRAWINGS

Working examples of the invention will be further elucidated in what follows with reference to the drawings. In the drawings there is shown in:

FIG. 1 a perspective view of a pillar member formed from a base plate and a support arm;

FIG. 2a a sectional view through the support arm and the base plate of the pillar member according to FIG. 1 during plugging of the support arm into the base plate;

FIG. 2b a second sectional view through the base plate and the support arm of the pillar member according to FIG. 1 in the plugged-in condition of the support arm;

FIG. 2c a sectional view through the pillar member of FIG. 1;

FIG. 3 an exploded view of a door member, composed of a base plate and a support arm and

FIG. 4 a sectional view of the door member according to FIG. 3 in the assembled condition.

### DETAILED DESCRIPTION

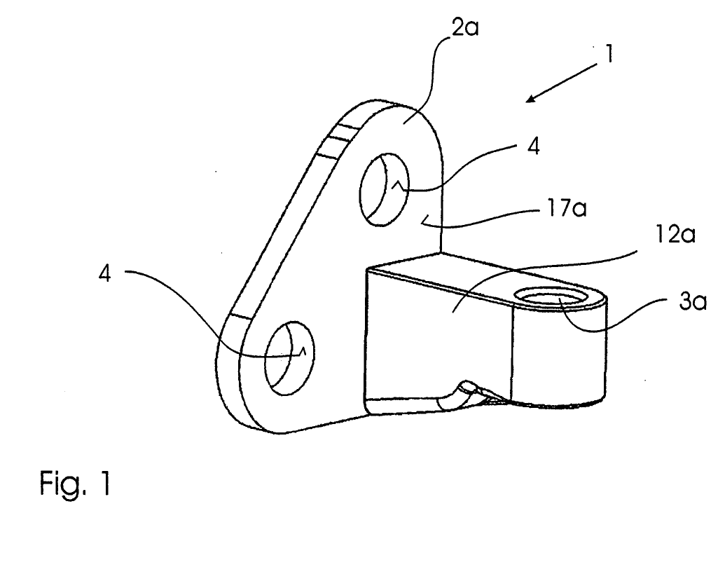

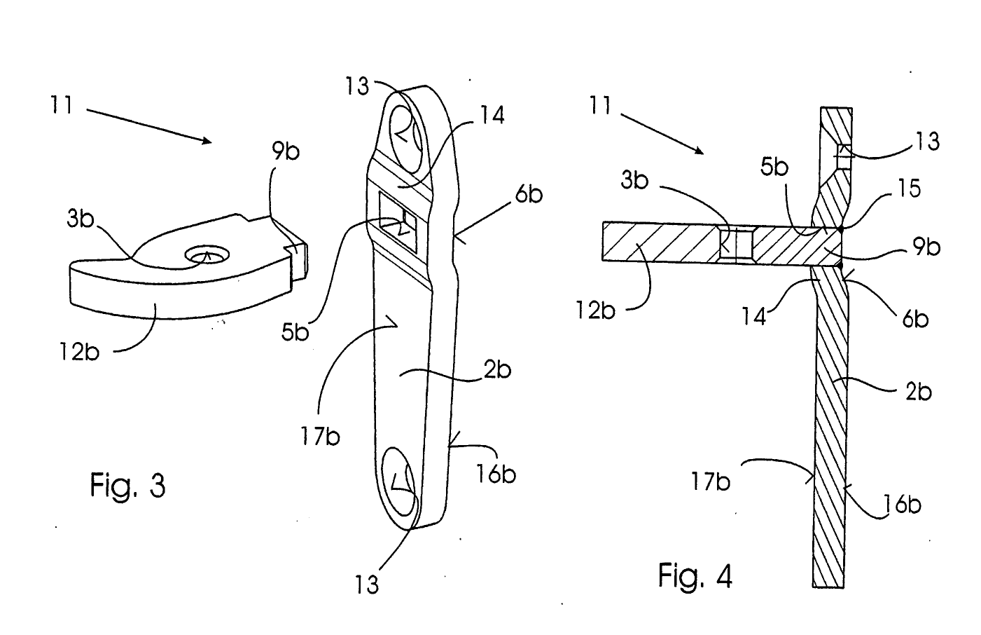

FIG. 1 shows a pillar member 1 produced from a base plate 2a and a support arm 12a. For fastening the pillar member 1 to a pillar, the base plate 2a is provided with two holes 4, which serve to accommodate fixing screws which are not illustrated here. The support arm 12a provided on the front face 17a of the base plate 2a includes a receiving aperture 3a for accommodating a hinge pin which, likewise, is not illustrated here, by means of which the pillar member 1 can be pivotally connected to, for example, the door member 11 illustrated in FIGS. 3 and 4.

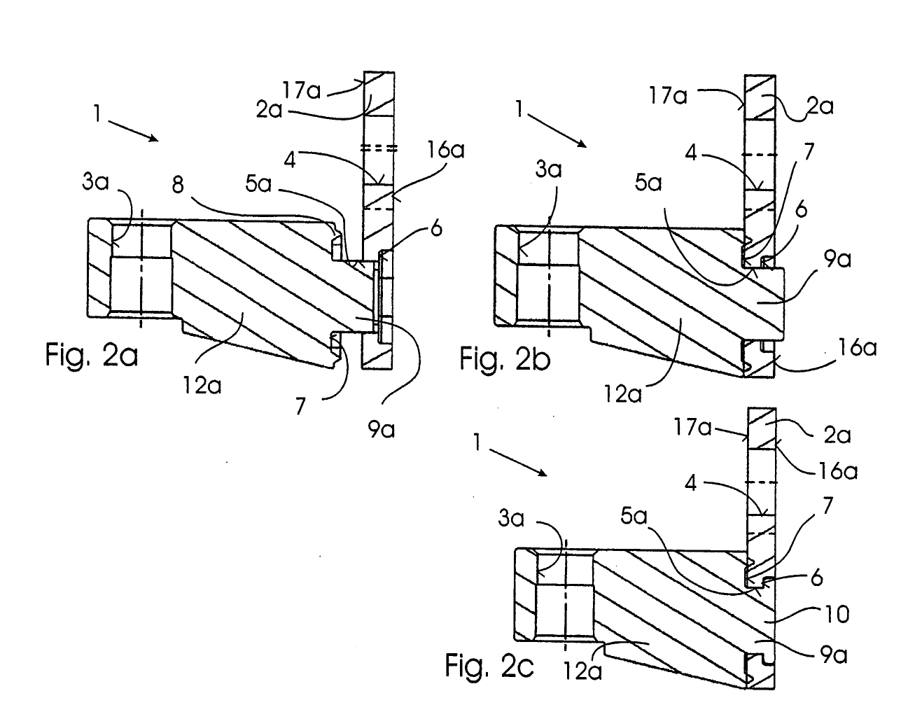

The manufacture of the pillar member 1 illustrated in FIG. 1 is shown in FIGS. 2a to 2c. The support arm 12a comprises at its end face 7 directed towards a front face 17a of the base plate 2a a welding seam 8, which is concentrically located around a peg 9a of the support arm 12a.

For assembly purposes, the peg 9a of the support arm 12a is inserted into an aperture 5a in the base plate 2a. In a first connecting step the welding seam 8 is caused to melt so that the end face 7 of the support arm 12a becomes bonded to the base plate 2a. In a second connecting step the peg 9a is spread open from a rear side 16a of the base plate 2a. The spreading 10 is now so arranged in a recess 6 in the rear side 16a of the base plate 2a that the peg 9a does not project beyond the rear side 16a of the base plate 2a.

The door member 11 illustrated in FIGS. 3 and 4 is likewise produced from a base plate 2b and a support arm 12b. For fixing the door member 11 to the vehicle door which is not illustrated here, the base plate 2b comprises two holes 13 for accommodating the fixing screws which, likewise have not been illustrated here.

At a connecting locality the base plate 2b comprises a ledge 14, which projects from a front face 17b of the base plate 2b. On its rear side 16b, opposite to the ledge 14, the base plate 2b comprises a recess 6b. For assembling the door member 11, the support arm 12b, by means of its peg 9b, is inserted into an aperture 5b provided in the region of the ledge 14 of the base plate 2b.

The plug-in connection so produced between the support arm 12b and the base plate 2b is secured in the region of the recess 6b on the rear side of the base plate 2b by a welding seam 15 there provided. The support arm 12b is provided with a receiving aperture 3b for the pivotal connection of the door member 11 by means of a hinge pin not illustrated here.

In a given set of components the support arm 12b can be fixed in two different positions to the base plate 2b, differing from one another by 180° C., thereby permitting the manufacture of a door member 11 which can be employed either on the right-hand or the left-hand side of a vehicle.

We claim:

1. Motor vehicle door hinge for the pivotal fitting of a vehicle door to a vehicle body, including
a door member adapted to be fitted to the vehicle door and
a pillar member adapted to be fitted to the vehicle body, these being pivotally interconnected, the pillar member and/or the door member being composed of at least two components, characterised in that a base plate (2a, 2b) adapted to be provided on the vehicle side and a support arm (12a, 12b) adapted to be fitted to the base plate (2a, 2b) each form one of the two components.

2. Motor vehicle door hinge according to claim 1, characterised in that the base plate (2a, 2b) and/or the support arm (12a, 12b) have been produced from a sheet metal blank.

3. Motor vehicle door hinge according to claim 1, characterised in that the base plate (2a, 2b) and/or the support arm (12a, 12b) have been produced from a cast, forged or extruded component.

4. Motor vehicle door hinge according to claim 1, characterised in that the base plate (2a, 2b) comprises an aperture (5a, 5b) for accommodating the support arm (12a, 12b).

5. Motor vehicle door hinge according to claim 1, characterised in that the connection between the support arm (12a, 12b) and the base plate (2a, 2b) is brought about by press-fitting.

6. Motor vehicle door hinge according to claim 1, characterised in that the base plate (2a, 2b) is connected by a bonding procedure to the support arm (12a, 12b).

7. Motor vehicle door hinge according to claim 6, characterised in that the base plate (2a, 2b) is connected by welding to the support arm (12a, 12b).

8. Motor vehicle door hinge according to claim 1, characterised in that the support arm (12a, 12b) is fitted in an aperture (5a, 5b) of the base plate (2a, 2b) by way of a connecting region (9a, 9b) and is connected to the rear side (16a, 16b) of the base plate (2a, 2b) in tight-fitting relationship by wedging up or riveting of the connecting region (9a, 9b).

9. Motor vehicle door hinge according to claim 8, characterised in that the connecting region (9a, 9b) of the support arm (12a, 12b) is formed by a peg (9a), which in the assembled state of the pillar member (1) and/or the door member (11) projects through the base plate (2a, 2b) and is connected at its free end to the base plate (2a) by riveting or wedging up.

10. Motor vehicle door hinge according to claim 1, characterised in that the base plate (2a 2b) on its front side (17a, 17b) facing the support arm (12a, 12b) in a connecting locality for the support arm (12a, 12b) comprises a ledge (14).

11. Motor vehicle door hinge according to claim 10, characterised in that the ledge (14) has been produced by stamping, such that the rear side (16b) of the base plate (2b) in the region of the ledge (14) is provided with a recess (6b).

12. Motor vehicle door hinge according to claim 1, characterised in that the base plate (2a, 2b) or the support arm (12a, 12b) in its contact region of the front side (17a, 17b) of the support arm (2a, 2b) with an end face (7) of the support arm (3a, 3b) comprises a welding seam (8) for projection welding.

13. Set of components for a vehicle door hinge, comprising a door member and a pillar member for the pivotal fitting of a vehicle door to a vehicle body including
a base plate adapted to be fitted to the vehicle door and/or the vehicle body and
a support arm which is connectable to the base plate,
the base plate and the support arm being adapted for the manufacture of a door member and/or pillar member which can be employed in at least two positions of a vehicle and wherein the base plate and the support arm are pre-manufactured.

14. Set of components according to claim 13, characterised in that the support arm (12a, 12b) is so designed that by reversal thereof it can be used for the manufacture of a pillar member (1) and/or a door member (11) on both sides of the vehicle.

15. Set of components according to claim 13, characterised in that the base plate (2a, 2b) and/or the support arm (12a, 12b) are formed from sheet metal blanks.

16. Set of components according to claim 13, characterised in that the base plate (2a, 2b) and/or the support arm (12a, 12b) are in the form of a solid casting, forging or extrusion component.

17. Set of components according to claim 13, characterised in that the base plate (2a, 2b) comprises an aperture (5a, 5b) for accommodating the support arm (12a, 12b).

18. Set of components according to claim 17, characterised in that the support arm (12a, 12b) comprises a peg (9a, 9b) for being accommodated in the aperture (5a, 5b) of the base plate (2a, 2b).
